(19) United States
(12) Patent Application Publication
(10) Pub. No.: US 2012/0145906 A1
(43) Pub. Date: Jun. 14, 2012

(54) Portable system for detecting explosives and a method of use thereof

(75) Inventors: Patrick Treado, Pittsburgh, PA (US); Matthew Nelson, Harrison City, PA (US); Charles W. Gardner, JR., Gibsonia, PA (US)

(73) Assignee: Chemlmage Corporation, Pittsburgh, PA (US)

(21) Appl. No.: 12/802,649

(22) Filed: Jun. 11, 2010

Related U.S. Application Data
(63) Continuation-in-part of application No. 11/366,532, filed on Mar. 3, 2006, now Pat. No. 7,738,095.
Application No. 11/366,532 is a continuation-in-part of application No. 12/754,229, filed on Apr. 5, 2010.
Application No. 12/754,229 is a continuation-in-part of application No. 12/719,904, filed on Mar. 9, 2010.
(60) Provisional application No. 61/268,885, filed on Jun. 17, 2009.
(60) Provisional application No. 61/278,393, filed on Oct. 6, 2009.
(60) Provisional application No. 61/335,785, filed on Jan. 12, 2010.
(60) Provisional application No. 61/301,814, filed on Feb. 5, 2010.
(60) Provisional application No. 61/395,440, filed on May 13, 2010.
(60) Provisional application No. 61/324,963, filed on Apr. 16, 2010.
(60) Provisional application No. 61/305,667, filed on Feb. 18, 2010.

(51) Int. Cl. G01J 3/42; G01J 5/20

(52) U.S. Cl. 250/338.4; 250/341.1; 250/341.8; 250/339.07; 250/339.01; 250/339.02

(57) ABSTRACT

A portable device for detecting explosives and other target materials using SWIR spectroscopic imaging, including hyperspectral imaging. The device may comprise a lens, a tunable filter, and a detector. The device may use solar radiation, or may comprise an illumination source such as a laser, to illuminate at target material and thereby produce interacted photons. The device may utilize multi-conjugate liquid crystal filter technology to filter interacted photons. The disclosure also provides for a method for using the portable device comprising illuminating a target material to produce interacted photons. The interacted photons are used to form a SWIR spectroscopic image, which may be a hyperspectral image. This image is analyzed to thereby identify the target material. This analysis may comprise comparing at least one spectrum or image representative of the target material to a reference spectrum or image. This comparison may be accomplished using a chemometric technique.

### RELATED APPLICATIONS

This application is a continuation-in-part of U.S. patent application Ser. No. 11/366,532, filed on Mar. 3, 2006, entitled “Method and Apparatus for Compact Spectrometer for Detecting Hazardous Agents”; a continuation-in-part of U.S. patent application Ser. No. 12/754,229, filed on Apr. 5, 2010, entitled “Chemical Imaging Explosives (CHIMED) Optical Sensor Using SWIR; and a continuation-in-part of U.S. patent application Ser. No. 12/719,904, filed on Mar. 9, 2010, entitled “Method and Apparatus for Compact Spectrometer for Multipoint Sampling of an Object.

This application also claims priority under 35 U.S.C §119(e) to the following U.S. Provisional Patent Application 61/278,855, filed on Jun. 17, 2009, entitled “SWIR Targeted Agile Raman (STAR) System for the OTM Detection of Emplace Explosives; 61/278,393, filed on Oct. 6, 2009, entitled “Use of Magnification to Increase SWIR HSI Detection Sensitivity”; 61/335,785, filed on Jan. 12, 2010, entitled “System and Method for SWIR HSI for Daytime and Nighttime Operations; 61/301,814, filed on Feb. 5, 2010, entitled “System and Method for Detection of Hazardous Agents Using SWIR, MWIR, and LWIR”; 61/395,440, filed on May 13, 2010, entitled “Portable System for Detecting Explosives and Method for Use Thereof”; 61/324,963, filed on Apr. 16, 2010, entitled “SWIR MCF”; and 61/305,667, filed on Feb. 18, 2010, entitled “System and Method for Detecting Explosives on Shoes and Clothing”.

Each of the above referenced applications is hereby incorporated by reference in their entireties.

### BACKGROUND

Spectroscopic imaging combines digital imaging and molecular spectroscopy techniques, which can include Raman scattering, fluorescence, photoluminescence, ultraviolet, visible and infrared absorption spectroscopy. When applied to the chemical analysis of materials, spectroscopic imaging is commonly referred to as chemical imaging.

Instruments for performing spectroscopic (i.e. chemical) imaging typically comprise an illumination source, image gathering optics, focal plane array imaging detectors and imaging spectrometers. In general, the sample size determines the choice of image gathering optic. For example, a microscope is typically employed for the analysis of sub micron to millimeter spatial dimension samples. For larger objects, in the range of millimeter to meter dimensions, macro lens optics are appropriate. For samples located within relatively inaccessible environments, flexible fiberscope or rigid borescopes can be employed. For very large scale objects, such as planetary objects, telescopes are appropriate image gathering optics.

For detection of images formed by the various optical systems, two-dimensional, imaging focal plane array (FPA) detectors are typically employed. The choice of FPA detector is governed by the spectroscopic technique employed to characterize the sample of interest. For example, silicon (Si) charge-coupled device (CCD) detectors or CMOS detectors are typically employed with visible wavelength fluorescence and Raman spectroscopic imaging systems, while indium gallium arsenide (InGaAs) FPA detectors are typically employed with near-infrared spectroscopic imaging systems.

Spectroscopic imaging of a sample can be implemented by one of two methods. First, a point-source illumination can be provided on the sample to measure the spectra at each point of the illuminated area. Second, spectra can be collected over the an entire area encompassing the sample simultaneously using an electronically tunable optical imaging filter such as an acousto-optic tunable filter (AOTF) or a liquid crystal tunable filter (“LCTF”). Here, the organic material in such optical filters is actively aligned by applied voltages to produce the desired bandpass and transmission function. The spectra obtained for each pixel of such an image thereby forms a complex data set referred to as a hyperspectral image which contains the intensity values at numerous wavelengths or the wavelength dependence of each pixel element in this image.

There currently exists a need to enhance a warfighter's capability to detect surface chemicals and explosives, explosive residue, and other hazardous and non-hazardous materials. There also exists a need to enhance warfighters' capability for dismounted situational awareness to rapidly detect in a noncontact, standoff mode the presence of surface chemicals and explosives residue within their environment. It would be advantageous if a portable and/or handheld device could be configured to provide rapid, accurate analysis of target materials present in a scene. It would also be advantageous if such a device could be configured to provide for On-the-Move (“OTM”) detection.

### SUMMARY OF THE INVENTION

The present disclosure provides for a portable system and method for detecting explosives and other materials using short wave infrared (“SWIR”) spectroscopic imaging. Spectroscopic imaging may include multispectral or hyperspectral imaging (“HSI”). HSI combines high resolution imaging with the power of massively parallel spectroscopy to deliver images having contrast that define the composition, structure, and concentration of a sample. HSI records an image and a fully resolved spectrum unique to the material for each pixel location in the image. Utilizing a liquid crystal imaging spectrometer, SWIR images are collected as a function of wavelength, resulting in a hyperspectral datacube where contrast is indicative of the varying amounts of absorbance, reflectance, scatter, or emission associated with the various materials present in the field of view (“FOV”). The hyperspectral datacube may be composed of a single spectroscopic method or a fusion of complimentary techniques.

The system and method of the present disclosure overcome the limitations of the prior art by providing for a portable SWIR sensor for rapid, wide area, noncontact, nondestructive detection of explosives and explosive and chemical residues in complex environments. The system and method of the present disclosure may also be used to detect explosive materials on surfaces such as metal, sand, concrete, skin, shoes, people, clothing, vehicles, baggage and entryways, and others. The system and method of the present disclosure hold potential for meeting the needs of warfighters to interrogate suspect vehicles, suspect individuals or suspect facilities in a standoff, wide area surveillance and covert manner. The portable device may be configured in a handheld embodiment, which may be carried by a warfighter as they move throughout a sample scene. It is also contemplated by the present disclosure that the portable device may be configured to operate in an OTM configuration, providing accurate detection of target materials while in motion.

### BRIEF DESCRIPTION OF THE DRAWINGS

The accompanying drawings, which are included to provide further understanding of the disclosure and are incorporated in and constitute a part of this specification, illustrate embodiments of the disclosure and, together with the description, serve to explain the principles of the disclosure.

The patent or application file contains at least one drawing executed in color. Copies of this patent or patent application publication with color drawing(s) will be provided by the Office upon request and payment of the necessary fee.

FIG. 1 is illustrative of a method of the present disclosure.

FIG. 2 is illustrative of exemplary packaging of one embodiment of a system of the present disclosure.

FIG. 3A is a schematic representation an embodiment of a system of the present disclosure. FIG. 3B is a schematic representation of another embodiment of a system of the present disclosure.

FIG. 4 is a comparison of the performance of one embodiment of a portable system (A) of the present disclosure and the performance of a full-sized system (B).

FIG. 5 illustrates detection capabilities of the system and method of the present disclosure.

### DETAILED DESCRIPTION

Reference will now be made in detail to the embodiments of the present disclosure, examples of which are illustrated in the accompanying drawings. Wherever possible, the same reference numbers will be used throughout the drawings to refer to the same or like parts.

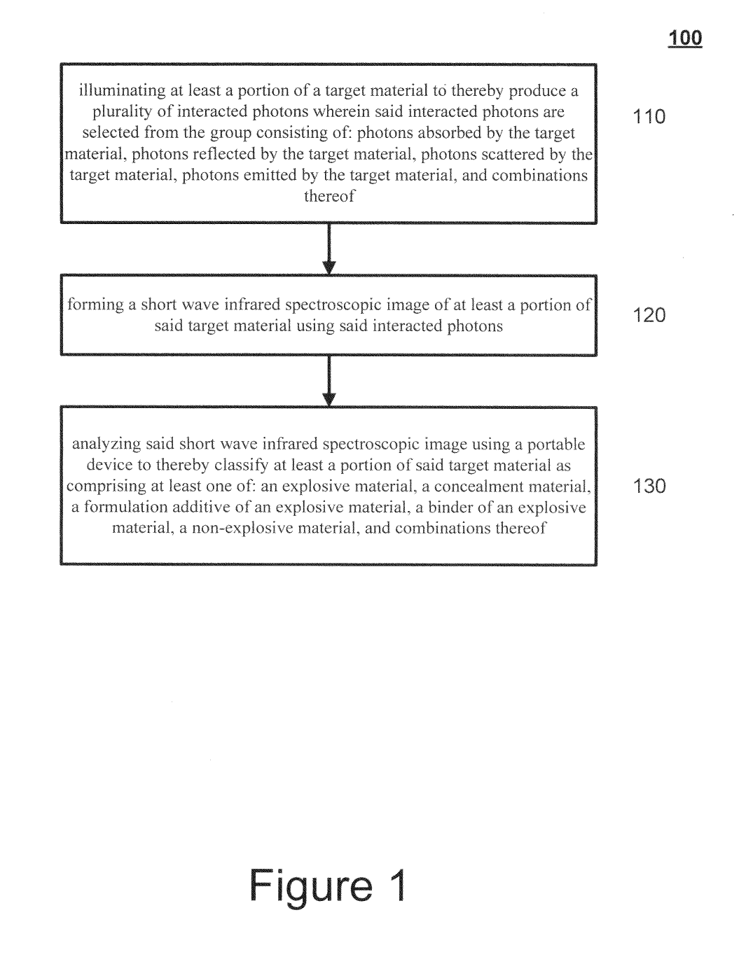

The present disclosure provides for a method for detecting explosives and other materials. In one embodiment, illustrated in FIG. 1, the method 100 comprises illuminating at least at portion of a target material in step 110 to thereby produce a plurality of interacted photons wherein said interacted photons are selected from the group consisting of: photons absorbed by the target material, photons reflected by the target material, photons scattered by the target material, photons emitted by the target material, and combinations thereof. In one embodiment, the target material is illuminated with illuminating photons emanating from the same portable device used to analyze the spectroscopic image. In another embodiment, the target material is illuminated using solar radiation (i.e., the sun). Therefore, the present disclosure contemplates both active and passive illumination configurations.

In step 120 a SWIR infrared spectroscopic image is formed of at least a portion of said target material using said interacted photons. In one embodiment, the SWIR spectroscopic image comprises a hyperspectral image. A hyperspectral image comprises an image and a fully resolved spectrum unique to the material for each pixel location in the image. In one embodiment, the spectroscopic image is a spatially accurate wavelength resolved image. In step 130 the SWIR spectroscopic image is analyzed using a portable device to thereby classify at least a portion of said target material as comprising at least one of: an explosive material, a concealment material, a formulation additive of an explosive material, a binder of an explosive material, a non-explosive material, and combinations thereof. In one embodiment, the portable device may comprise a handheld device.

The present disclosure contemplates a quick analysis time, measured in terms of seconds. For example, various embodiments may contemplate analysis time in the order of <10 seconds, <5 seconds, and <2 seconds. Therefore, the present disclosure contemplates substantially simultaneous acquisition and analysis of spectroscopic images.

In one embodiment, this analyzing may comprise comparing at least one spectra representative of the target material with at least one reference spectra representative of a known material to thereby determine at least one of: said target material comprises said known material, and said target material does not comprise said known material.

In another embodiment, analyzing the SWIR spectroscopic image may comprise comparing at least one SWIR spectroscopic image representative of at least a portion of the target material with a reference SWIR spectroscopic image representative of a known material to thereby determine at least one of: said target material comprises said known material and said target material does not comprise said known material. In one embodiment, these reference images and reference spectra may be stored in the memory of the device itself. In another embodiment, the device may also be configured for remote communication with a host station using a wireless link to report important findings or update its reference library.

In one embodiment, this comparison may be achieved by applying a chemometric technique. This technique may be any known in the art, including but not limited to: principle component analysis, partial least squares discriminate analysis, cosine correlation analysis, Euclidian distance analysis, k-means clustering, multivariate curve resolution, band t. entropy method, mahalanobis distance, adaptive subspace detector, spectral mixture resolution, and combinations thereof. In another embodiment, pattern recognition algorithms may be used.

The interacted photons generated as a result of illuminating the target material may be passed through a tunable filter. In one embodiment, this tunable filter may comprise a multi-conjugate liquid crystal tunable filter (“MCF”). The MCF is a type of liquid crystal tunable filter (“LCTF”) which consists of a series of stages composed of polarizers, retarders, and liquid crystals. The MCF is capable of providing diffraction limited spatial resolution, and a spectral resolution consistent with a single stage dispersive monochromator. The MCF may be computer controlled, with no moving parts, and may be tuned to any wavelength in the given filter range. This results in the availability of hundreds of spectral bands. In one embodiment, the individual liquid crystal stages are tuned electronically and the final output is the convolved response of the individual stages. The MCF holds potential for higher optical throughput, superior out-of-band rejection and faster tuning speeds.

In one embodiment, the MCF may comprise MCF technology available from ChemImage Corporation, Pittsburgh, Pa. This technology is more fully described in U.S. Pat. No. 7,362,489, filed on Apr. 22, 2005, entitled “Multi-Conjugate Liquid Crystal Tunable Filter” and U.S. Pat. No. 6,692,809, filed on Feb. 2, 2005, also entitled “Multi-Conjugate Liquid Crystal Tunable Filter.” In another embodiment, the MCF technology used may comprise a SWIR multi-conjugate tunable filter. One such filter is described in U.S. Patent Application No. 61/324,963, filed on Apr. 16, 2010, entitled “SWIR MCF”. Each of these patents are hereby incorporated by reference in their entireties.

In another embodiment, the interacted photons may be passed through a filter selected from the group consisting of: a liquid crystal tunable filter, a SWIR liquid crustal tunable filter, acousto-optical tunable filters, Lyot liquid crystal tunable filter, Evans Split-Element liquid crystal tunable filter, Solc liquid crystal tunable filter, Ferroelectric liquid crystal tunable filter, Fabry Perot liquid crystal tunable filter, and combinations thereof.

The present disclosure also provides for a portable device for detecting explosives and other materials. In one embodiment, the device may comprise a lens for collecting a plurality of interacted photons wherein said interacted photons are selected from the group consisting of: photons absorbed by a target material, photons reflected by a target material, photons scattered by a target material, photons emitted by a target material, and combinations thereof. The interacted photons may be generated by illuminating at least a portion of a target material with illuminating photons. In an active illumination configuration, the target material may be illuminated by photons emanating from the portable device. In one embodiment, active illumination of a target material may be accomplished via laser illumination. In a passive illumination configuration, the target material may be illuminated by a solar radiation source (i.e., the sun).

The device may further comprise a tunable filter through which said interacted photons are passed. In one embodiment, this filter may comprise a MCF. The device may further comprise a detector for collecting the filtered interacted photons and forming a SWIR spectroscopic image representative of at least a portion of the target material. In one embodiment, this spectroscopic image may comprise a hyperspectral image. This detector may be a focal plane array detector. In one embodiment, the detector may comprise an InGaAs focal plane array detector. In another embodiment, an OEM modules may be implemented rather than a full size camera module.

In one embodiment, the device may further comprise an embedded processor. Embedded processor technology holds potential for real-time processing and decision-making. The use of a MCF and embedded processor technology holds potential for achieving faster wavelength switching, image capture, image processing and explosives detection. In one embodiment, the device may further comprise a camera configured to provide a visible image. This camera may comprise an RGB camera, including an RGB video camera. This element may be implemented to output a dynamic image of a scene comprising a number of target materials. This may be used in an OTM configuration to scan a scene for potential threats. In one embodiment, the sensor may be configured to operate at speeds of up to 15-20 mph. One method for dynamic chemical imaging is more fully described in U.S. Pat. No. 7,046,359, filed on Jun. 30, 2004, entitled “System and Method for Dynamic Chemical Imaging”, which is hereby incorporated by reference in its entirety.

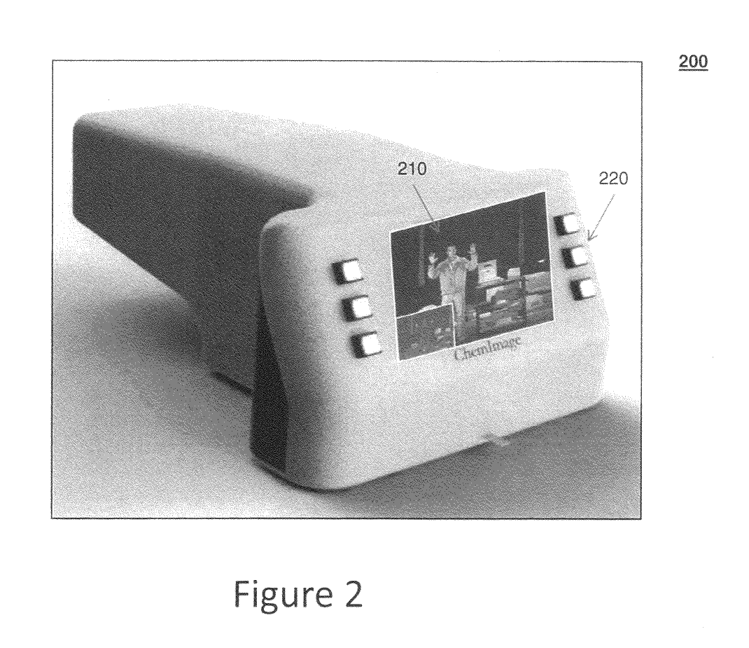

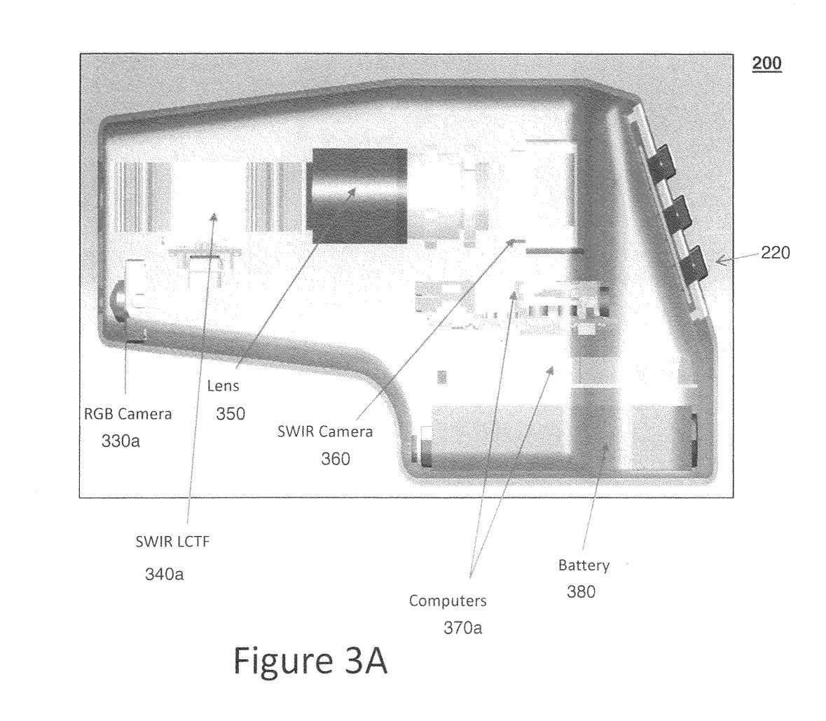

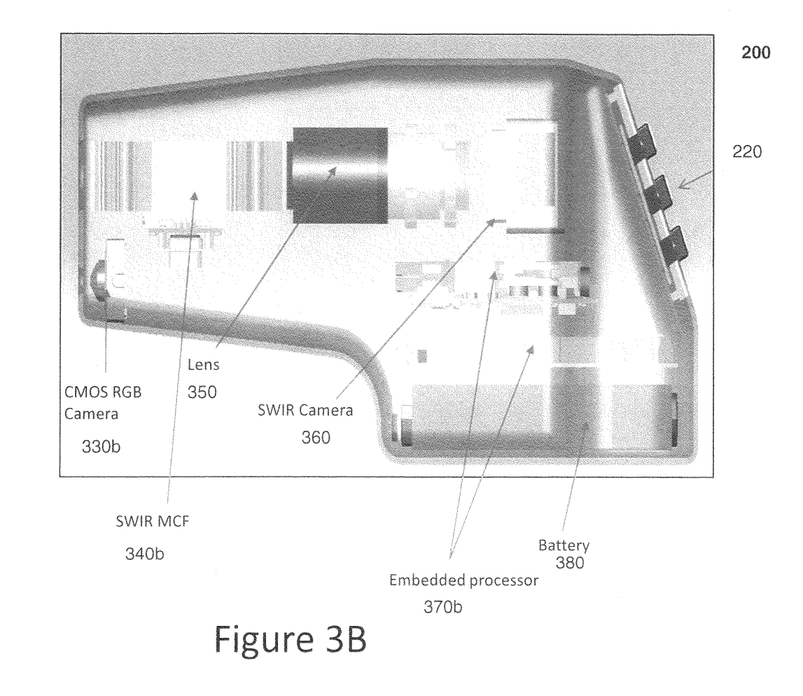

Embodiments of the portable device of present disclosure are illustrated in FIGS. 2, 3A and 3B. FIG. 2 is provided to illustrate an exemplary packaging option of the portable device 200. As illustrated, the device 200 may comprise a display screen 210. This display screen may display a result including at least one of: an image, a spectrum, a text message, a working indication, or other information that can be used to identify the target material. In one embodiment, the visual indicator may be complemented by an audio warning signal or other identification means. In another embodiment, the display screen may be configured to display more than one image at a time. In one embodiment, a video image may be provided along with a SWIR spectroscopic image and/or a dynamic image.

The device 200 may also comprise controls 220 or a keypad (not illustrated). These elements may be used for control and inputting data or for addressing commands to another unit of the device.

FIG. 3A is a schematic representation of one embodiment of the device of the present disclosure. In such an embodiment, the device 200 comprises: a RGB camera 330a, a SWIR LCTF 340a, a lens 350, a SWIR camera 360, computers 370a, and a battery 380 which is used as a power source for the device. The RGB camera may be configured to provide a dynamic image of a scene and may be implemented in an OTM configuration. The SWIR LCTF may comprise a SWIR MCF in one embodiment to provide for faster wavelength switching. In one embodiment, the computers 370 may comprise embedded processor technology. In one embodiment, the device may comprise a CMOS RGB camera. In one embodiment, the device may comprise a fixed focal length lens.

FIG. 3B illustrates another embodiment of the present disclosure. In such an embodiment, the device 200 comprises: controls 220, a CMOS RGB camera 330b, a SWIR MCF 340b, a lens 350, a SWIR camera 360, an embedded processor 370b, and a battery 380.

The embodiments of FIGS. 3A and 3B is configured for passive illumination (i.e., solar radiation). However, a laser or other illumination source may also be included in the device to provide for active illumination. In one embodiment, the device may further comprise one or more communication ports for electronically communicating with other electronic equipments such as a server or printer. In one embodiment, such communication may be used to communicate with a reference database or library comprising at least one of: a reference spectra corresponding to a known material and a reference short wave infrared spectroscopic image representative of a known material. In such an embodiment, the device may be configured for remote communication with a host station using a wireless link to report important findings or update its reference library. In another embodiment, this reference database may be stored in the memory of the device itself.

Another embodiment of the present disclosure provides for a portable device, the device comprising: a means for illuminating at least a portion of a target material to thereby generate a plurality of interacted photons wherein said interacted photons are selected from the group consisting of: photons absorbed by the target material, photons reflected by the target material, photons scattered by the target material, photons emitted by the target material, and combinations thereof; a means for forming a short wave infrared spectroscopic image representative of at least a portion of said target material; and a means for analyzing said SWIR spectroscopic image to thereby determine whether said target material comprises at least one of: an explosive material, a concealment material, a formulation additive of an explosive material, a binder of an explosive material, a non-explosive material, and combinations thereof. In one embodiment, the device may further comprise a filter wherein said filter is selected from the group consisting of: a multi-conjugate tunable filter, a liquid crystal tunable filter, acousto-optical tunable filters, Lyot liquid crystal tunable filter, Evans Split-Element liquid crystal tunable filter, Solc liquid crystal tunable filter, Ferroelectric liquid crystal tunable filter, Fabry Perot liquid crystal tunable filter, and combinations thereof. In another embodiment, the spectroscopic image may comprise a hyperspectral image.

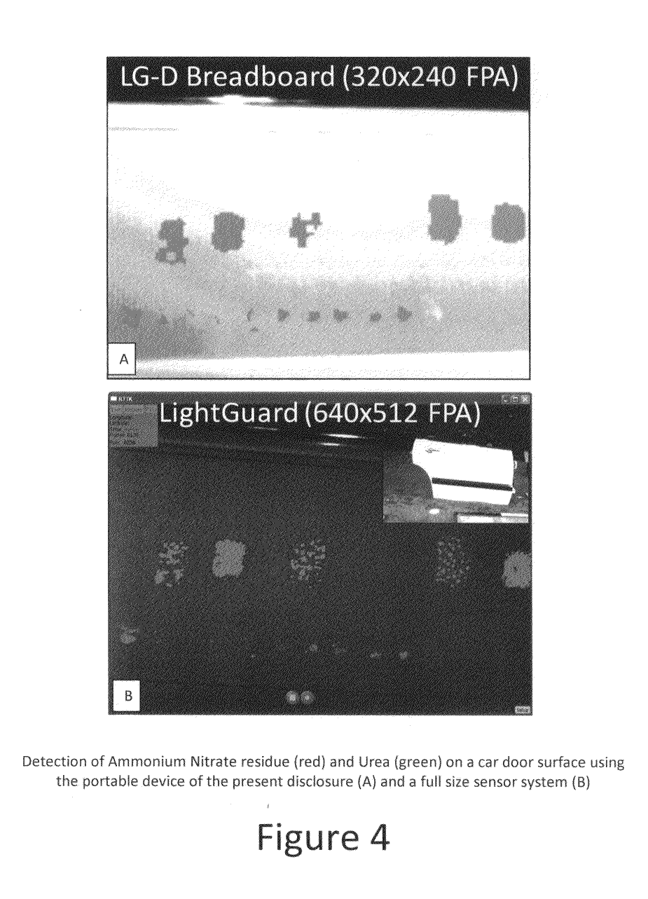

FIGS. 4A and 4B are provided to compare the performance of the portable system of the present disclosure (FIG. 4A) with a full-sized system (FIG. 4B). Both systems were able to accurately detect Ammonium Nitrate (red) and Urea residue (green). Therefore, the portable system described herein holds potential for performing as well as a full-sized system.

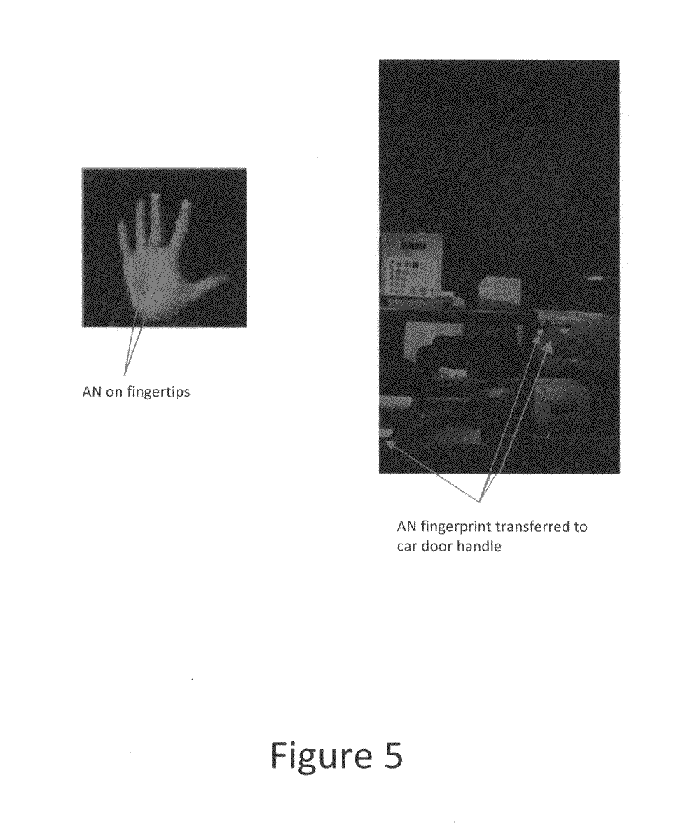

In one embodiment, the present disclosure may implement CONDOR-ST technology, available from ChemImage Corporation, Pittsburgh, Pa. This technology maybe referred to commercially in a handheld configuration as “Roadrunner”. FIG. 5 illustrates standoff detection using CONDOR-ST, Gen 2 technology. As illustrated, the device of the present disclosure holds potential for detecting explosives residue on surfaces such as human skin and car doors. In this analysis, a SWIR hyperspectral image is collected and processed using processing methods known in the art.

In one embodiment of the present disclosure, SWIR hyperspectral imaging may be achieved using a sensor mounted to a vehicle for OTM detection. In another embodiment, the sensor may be mounted to a platform for stationary surveillance and detection. This embodiment provides for standoff detection and may be used in EOD, route clearance, tactical and convoy operations. In one embodiment, the device may be configured to provide detection performance at ranges of up to 20 m standoff distance, which includes high probability of detection (P_{D}) and low false alarm rate (FAR).

The following Tables show non-exclusive and exemplary specifications for embodiments of the portable device of the present disclosure.

TABLE 1

| Performance | |
|---|---|
| Parameter | Specification |
| Sensing modality | SWIR(900-1700 nm at 8 nm bandpass) |
| | hyperspectral imaging spectroscopy |
| Types of targets | Chemicals and explosives on surfaces (i.e., |
| | metal, sand, concrete, skin, etc.) |
| Time to detect | <2 seconds depending on target type, |
| | concentration, and operation conditions |
| Detection range | 20 m |
| Size | Est. 6″ wide × 5″ high × 10″ long |
| Weight | Est. <5 lbs |
| Power required | 100 watts |
| Maturity | TRL 6+ |
| Safety issues | None, passive sensor, eye safe, radiation safe |

TABLE 2

| Performance | |
|---|---|
| Parameter | Specification |
| Sensing modality | SWIR(900-1700 nm at 8 nm bandpass) |
| | hyperspectral imaging spectroscopy |
| Types of targets | Disturbed earth, IED camo, explosives on |
| | surfaces, command wires |
| Time to detect | Approx. 1-2 seconds |
| Detection range | 1-20 m depending on target type, concentration, |
| | and operation conditions |
| Size | Est. 6″ wide × 5″ high × 12″ long |
| Weight | Est. <10 lbs |
| Power required | 100 watts |
| Maturity | TRL 3 |
| Safety issues | None, passive sensor, eye safe, radiation safe |

Although the disclosure is described using illustrative embodiments provided herein, it should be understood that the principles of the disclosure are not limited thereto and may include modification thereto and permutations thereof. These modifications may include but are not limited to extending this type of detection to other spectroscopic modalities including fluorescence, Raman, infrared, visible, and ultra violet.

What is claimed is:

1. A method comprising:
illuminating at least a portion of a target material to thereby produce a plurality of interacted photons wherein said interacted photons are selected from the group consisting of: photons absorbed by the target material, photons reflected by the target material, photons scattered by the target material, photons emitted by the target material, and combinations thereof;
forming a short wave infrared spectroscopic image of at least a portion of said target material using said interacted photons;
analyzing said short wave infrared spectroscopic image using a portable device to thereby classify at least a portion of said target material as comprising at least one of: an explosive material, a concealment material, a formulation additive of an explosive material, a binder of an explosive material, a non-explosive material, and combinations thereof.

2. The method of claim 1 wherein said short wave infrared spectroscopic image comprises a hyperspectral image, wherein said hyperspectral image comprises an image and a fully resolved spectrum unique to the material for each pixel location in said image.

3. The method of claim 1 wherein said image is a spatially accurate wavelength resolved image.

4. The method of claim 1 wherein said portable device comprises a handheld device.

5. The method of claim 2 wherein said analyzing comprises comparing at least one spectra representative of said target material with at least one reference spectra representative of a known material to thereby determine at least one of: said target material comprises said known material, and said target material does not comprise said known material.

6. The method of claim 5 wherein said comparing is achieved by using a chemometric technique.

7. The method of claim 6 wherein said chemometric technique is selected from the group consisting of: principle components analysis, partial least squares discriminate analysis, cosine correlation analysis, Euclidian distance analysis, k-means clustering, multivariate curve resolution, band t. entropy method, mahalanobis distance, adaptive subspace detector, spectral mixture resolution, and combinations thereof.

8. The method of claim 1 wherein said analyzing comprises comparing at least one short wave infrared spectroscopic image representative of said target material with at least one reference short wave infrared spectroscopic image representative of a known material to thereby determine at least one of: said target material comprises said known material, said target material does not comprise said known material, and combinations thereof.

9. The method of claim 8 wherein said comparing is achieved by using a chemometric technique.

10. The method of claim 9 wherein said chemometric technique is selected from the group consisting of: principle components analysis, partial least squares discriminate analysis, cosine correlation analysis, Euclidian distance analysis, k-means clustering, multivariate curve resolution, band t. entropy method, mahalanobis distance, adaptive subspace detector, spectral mixture resolution, and combinations thereof.

11. The method of claim 1 wherein said target material is illuminated using photons emanating from said portable device.

12. The method of claim 1 wherein said target material is illuminated using solar radiation.

13. The method of claim 1 further comprising passing said interacted photons through a tunable filter selected from the group consisting of: a multi-conjugate tunable filter, a liquid crystal tunable filter, acousto-optical tunable filters, Lyot liquid crystal tunable filter, Evans Split-Element liquid crystal tunable filter, Solc liquid crystal tunable filter, Ferroelectric liquid crystal tunable filter, Fabry Perot liquid crystal tunable filter, and combinations thereof.

14. A portable device comprising:
a means for illuminating at least a portion of a target material to thereby generate a plurality of interacted photons wherein said interacted photons are selected from the group consisting of photons absorbed by said target material, photons reflected by said target material, photons scattered by said target material, photons emitted by said target material, and combinations thereof;
a means for forming a short wave infrared spectroscopic image of at least a portion of said target material;
a means for analyzing said short wave infrared spectroscopic image to thereby determine whether said target material comprises at least one of: an explosive material, a concealment material, a formulation additive of an explosive material, a binder of an explosive material, a non-explosive material, and combinations thereof.

15. The device of claim 14 further comprising a filter wherein said filter is selected from the group consisting of: a multi-conjugate tunable filter, a liquid crystal tunable filter, acousto-optical tunable filters, Lyot liquid crystal tunable filter, Evans Split-Element liquid crystal tunable filter, Solc liquid crystal tunable filter, Ferroelectric liquid crystal tunable filter, Fabry Perot liquid crystal tunable filter, and combinations thereof.

16. A portable device comprising:
a lens for collecting a plurality of interacted photons wherein said interacted photons are photons selected from the group consisting of: photons absorbed by a target material, photons reflected by a target material, photons scattered by a target material, photons emitted by a target material, and combinations thereof, and wherein said interacted photons are generated by illuminating at least a portion of said target material;
a tunable filter through which said interacted photons are passed;
a detector for collecting said interacted photons and forming a short wave infrared spectroscopic image representative of at least a portion of said target material.

17. The device of claim 16 further comprising an illumination source for illuminating at least a portion of said target material.

18. The device of claim 16 wherein said tunable filter comprises a multi-conjugate tunable filter.

19. The device of claim 16 wherein said filter comprises a filter selected from the group consisting of: a multi-conjugate tunable filter, a liquid crystal tunable filter, acousto-optical tunable filters, Lyot liquid crystal tunable filter, Evans Split-Element liquid crystal tunable filter, Sole liquid crystal tunable filter, Ferroelectric liquid crystal tunable filter, Fabry Perot liquid crystal tunable filter, and combinations thereof.

20. The device of claim 19 wherein said detector comprises a focal plane array detector.

21. The device of claim 20 wherein said focal plane array detector comprises an InGaAs focal plane array detector.

22. The device of claim 19 further comprising an embedded processor.

23. The device of claim 19 further comprising providing a reference database wherein said reference database comprises at least one of: a reference short wave infrared spectrum corresponding a known material, a reference short wave infrared spectroscopic image corresponding to a known material, and combinations thereof.

24. The device of claim 16 further comprising a means for analyzing said short wave infrared spectroscopic image to thereby determine whether said target material comprises at least one of: an explosive material, a concealment material, a formulation additive of an explosive material, a binder of an explosive material, anon-explosive material, and combinations thereof.

25. The device of claim 16 wherein said short wave infrared spectroscopic image comprises a hyperspectral image.

26. The device of claim 16 further comprising a RGB camera.
